(19) United States
(12) Patent Application Publication
(10) Pub. No.: US 2018/0211789 A1
(43) Pub. Date: Jul. 26, 2018

(54) CAPACITOR AND CAPACITOR MANUFACTURING METHOD

(71) Applicant: NIPPON CHEMI-CON CORPORATION, Tokyo (JP)

(72) Inventors: Masayuki Mori, Tokyo (JP); Masaru Saito, Tokyo (JP); Koji Hoshino, Tokyo (JP); Takashi Kuroki, Tokyo (JP)

(73) Assignee: NIPPON CHEMI-CON CORPORATION, Tokyo (JP)

(21) Appl. No.: 15/745,547

(22) PCT Filed: Jul. 26, 2016
(86) PCT No.: PCT/JP2016/003455

§ 371 Date: Jan. 17, 2018

(30) Foreign Application Priority Data
Jul. 27, 2015 (JP) 2015-147394

(51) Int. Cl. H01G 9/048; H01G 9/00; H01G 11/26; H01G 11/70; H01G 11/86

(52) U.S. Cl. CPC H01G 9/048; H01G 9/0029; H01G 11/86; H01G 11/70; H01G 11/26

(57) ABSTRACT

A capacitor includes a capacitor element including a positive electrode body and a negative electrode body that are layered with a separator and wound; a positive electrode portion formed onto one end face of the capacitor element, and being pulled out from the positive electrode body; a negative electrode portion formed onto the same end face as the positive electrode portion, and being pulled out from the negative electrode body, an insulating space being disposed between the negative electrode portion and the positive electrode portion; and current collecting plates on a positive electrode side and a negative electrode side connected to a side of flattened portions on the positive electrode portion and the side of flattened portions on the negative electrode portion by welding in a direction intersecting the positive electrode body and the negative electrode body that are layered, respectively.

### TECHNICAL FIELD

The present invention relates to a manufacturing technique of a capacitor using a wound element such as an electric double-layer capacitor or an electrolytic capacitor.

### BACKGROUND ART

For a capacitor such as an electric double-layer capacitor or an electrolytic capacitor, the area of an electrode body is related to the magnitude of the capacitance. To manufacture a capacitor, downsizing and a larger capacitance are realized by winding electrode bodies each having a large area around the element center.

As to the above capacitor, a capacitor is present that uses a capacitor element including a positive electrode body and a negative electrode body wound on each other through a separator therebetween (for example, Patent Literature 1).

### CITATION LIST

### Patent Literature

Patent Literature 1: Japanese Laid-Open Patent Publication No. 2001-068379

### SUMMARY OF INVENTION

### Technical Problem

A capacitor having a shape other than a circular column shape may be used in accordance with an installation space or the like for a device, an apparatus or the like that has the capacitor mounted thereon. For example, a flattened-shape capacitor element is used in the capacitor having the shape other than the circular column shape. With this capacitor element, for example, the force acting on the wound electrode bodies is not uniform, a restoring force may therefore be generated in a portion thereof, and the outer shape of the capacitor element may therefore be deformed. The capacitor element may also be deformed to outspread by receiving externally applied vibrations or an influence of expansion caused by the impregnation of an electrolytic solution for example.

When the capacitor element, for example, outspreads as the deformation, the contact between the electrode bodies is degraded and problems therefore arise that an increase of the internal resistance and degradation of the electric functions may be caused. When a countermeasure is taken such as enclosing the capacitor element in a case to cope with the outspreading deformation of the capacitor element, an excessive stress is applied to a portion of the capacitor element, and an increase of the internal resistance of the capacitor, degradation of the electric properties thereof, and the like may thereby occur. When the capacitor element is deformed, in addition to moving connection positions for connecting the electrode portions to current collecting plates and terminal parts, an excessive load is applied to connecting portions, and influences may thereby occur such as breakage of the capacitor element and degradation of the electric properties, and the like.

Patent Literature 1 includes no disclosure and no suggestion in relation to the problems and the problems cannot be solved with the configuration disclosed in Patent Literature 1.

An object of the capacitor manufacturing method and the capacitor of the present invention is to stabilize the shape of the capacitor element.

Another object of the capacitor manufacturing method and the capacitor of the present invention is to stabilize the connection state between the electrode portions and the terminal parts.

### Solution to Problem

To achieve the above objects, an aspect of a capacitor of the present invention may include a capacitor element including a positive electrode body and a negative electrode body that are layered with a separator, the positive electrode body, the negative electrode body and the separator being wound, the capacitor element being formed in a flattened shape and having curved portions and flattened portions; a positive electrode portion formed onto one end face of the capacitor element, the positive electrode portion being pulled out from the positive electrode body; a negative electrode portion formed onto the same end face as the positive electrode portion, the negative electrode portion being pulled out from the negative electrode body, an insulating space being disposed between the negative electrode portion and the positive electrode portion; and current collecting plates on a positive electrode side and a negative electrode side connected to a side of the flattened portions on the positive electrode portion and the side of the flattened portions on the negative electrode portion by welding in a direction intersecting the positive electrode body and the negative electrode body that are layered, respectively.

In the capacitor, preferably, the current collecting plates on the positive electrode side and the negative electrode side may each be arranged on the flattened portions and one of the curved portions, and may be connected by welding on the curved portions.

In the capacitor, preferably, a side of the flattened portions facing each other through a central portion of the capacitor element may be connected onto one of the current collecting plates by a series of welding processes.

In the capacitor, preferably, a spacer may be arranged in the central portion of the capacitor element.

To achieve the objectives, an aspect of a capacitor manufacturing method of the present invention may include the steps of winding a positive electrode body and a negative electrode body that are layered with a separator, and forming a flattened-shape capacitor element that has curved portions and flattened portions; forming a positive electrode portion that is pulled out from the positive electrode body and a negative electrode portion that is pulled out from the negative electrode body, on one end face of the capacitor element, and disposing an insulating space between the negative electrode portion and the positive electrode portion; and connecting a positive electrode terminal disposed on an opening sealing plate and the positive electrode portion to each other through a current collecting plate on a positive electrode side, the opening sealing plate being for sealing an opening of a case member accommodating the capacitor element, and connecting a negative electrode terminal on the opening sealing plate and the negative electrode portion to each other through a current collecting plate on a negative electrode side. The aspect may further include the step of connecting each of the current collecting plates onto the positive electrode portion or the negative electrode portion by welding in a direction intersecting the positive electrode body and the negative electrode body that are layered.

### Advantageous Effects of Invention

According to the present invention, any one of the following effects is achieved.

(1) The restoring force generated in the electrode body can be coped with by connecting the flattened portions of the capacitor element to the current collecting plate arranged over the central portion of the capacitor element, and the shape of the capacitor element can be maintained.

(2) The contact state of the layered electrode bodies can be maintained and reduction of the internal resistance of the capacitor element can be facilitated because any deformation of the flattened portions is avoided by the connection of the current collecting plate.

(3) Improvement of the connection strength for the positive electrode portion and the negative electrode portion, and improvement of the electric connection can be facilitated by executing welding for the current collecting plate in the direction intersecting the positive electrode body and the negative electrode body layered on each other.

### BRIEF DESCRIPTION OF DRAWINGS

FIG. 1 is a diagram of a configuration example of a capacitor element and a current collecting plate according to a first embodiment.

FIG. 2 is a diagram of a configuration example of the capacitor element.

FIG. 3 is a diagram of an example of a welding process for the current collecting plate.

FIG. 4 is a diagram of a configuration example of a capacitor element and a current collecting plate according to a second embodiment.

FIG. 5 is a diagram of a configuration example of insertion of a spacer into the capacitor element.

FIG. 6 is a diagram of an example of connection of the capacitor element and a terminal part to each other.

### DESCRIPTION OF EMBODIMENTS

### First Embodiment

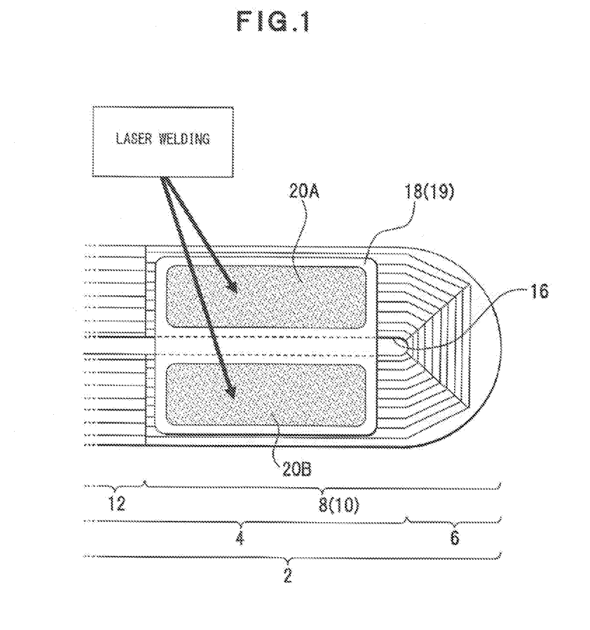

FIG. 1 depicts a configuration example of a capacitor element and a current collecting plate according to a first embodiment. The configuration depicted in FIG. 1 is an example and the present invention is not limited to this configuration.

The capacitor element 2 is an example of a constituent part of a capacitor of the present invention; the capacitor element 2 includes flattened portions 4 and curved portions 6, for example, as depicted in FIG. 1; the flattened portions 4 have electrode bodies and separators, for example, that form the capacitor element 2 and are layered with each other in a straight line form or a substantially straight line form; the curved portions 6 are formed on both end sides of the flattened portions 4, respectively and are formed by bending the electrode bodies; and the capacitor element 2 has a flattened column-like shape. Seen from, for example, the side of an end face side of the element, the capacitor element 2 is formed for the flattened portion 4 to be a side longer than the width of the curved portion 6. The capacitor element 2 is an example of an element of an electric double-layer capacitor, an electrolytic capacitor, a hybrid capacitor, or the like. The manufacturing process of the capacitor element 2 is an example of a capacitor manufacturing method of the present invention.

On one end face of the capacitor element 2, a positive electrode portion 8 and a negative electrode portion 10 are formed on the sides of the curved portions 6 in addition to portions of right half flattened portions 4 and left half flattened portions 4 with, for example, the central portion in the long side direction of the flattened portions 4 as a border, respectively. In the central portion in the long side direction of the flattened portions 4, an insulating space 12 is disposed that insulates the positive electrode portion 8 and the negative electrode portion 10 from each other. A flattened-shape hollow portion 16 as the central portion of the element is formed in the capacitor element 2. The opening width and the opening length of the hollow portion 16 is set during the shaping process of the capacitor element 2. When the electrode bodies etc. are layered with each other or are wound for the capacitor element 2 to have a flattened shape in advance, the length and the thickness are set at the central axis. When the capacitor element 2 is formed to have a flattened shape by pressing or the like the capacitor element 2 formed in a cylinder shape, the length and the width of the hollow portion 16 are set based on, for example, the force of the pressing and the range of the pressing.

The positive electrode portion 8 and the negative electrode portion 10 are connected to current collecting plates 18 and 19, respectively, and are connected to terminal parts for electrically connecting the capacitor to another electronic device or the like. The current collecting plates 18 and 19 are formed from an electrically conductive material such as a metal and include flat face portions connected to the positive electrode portion 8 and the negative electrode portion 10 formed on the flattened portions 4 sandwiching the hollow portion 16 therebetween. Each of the flat face portions of the current collecting plates 18 and 19 is arranged on and is connected to an end face of the positive electrode portion 8 or the negative electrode portion 10 extending over the hollow portion 16.

Connecting portions between the positive electrode portion 8 or the negative electrode portion 10, and the current collecting plate 18 or the current collecting plate 19 is formed by, for example, laser welding. The positions of the connecting portions are present in connection ranges 20A and 20B that are arranged on at least the positive electrode portion 8 or the negative electrode portion 10 on the flattened portions 4 side, relative to the flat face portions of the current collecting plates 18 and 19. The connecting portions may be formed by, for example, one welding step with a predetermined distance in each of the connection ranges 20A and 20B or may be formed by welding plural points in each of the connection ranges 20A and 20B.

### Configuration of Capacitor Element 2

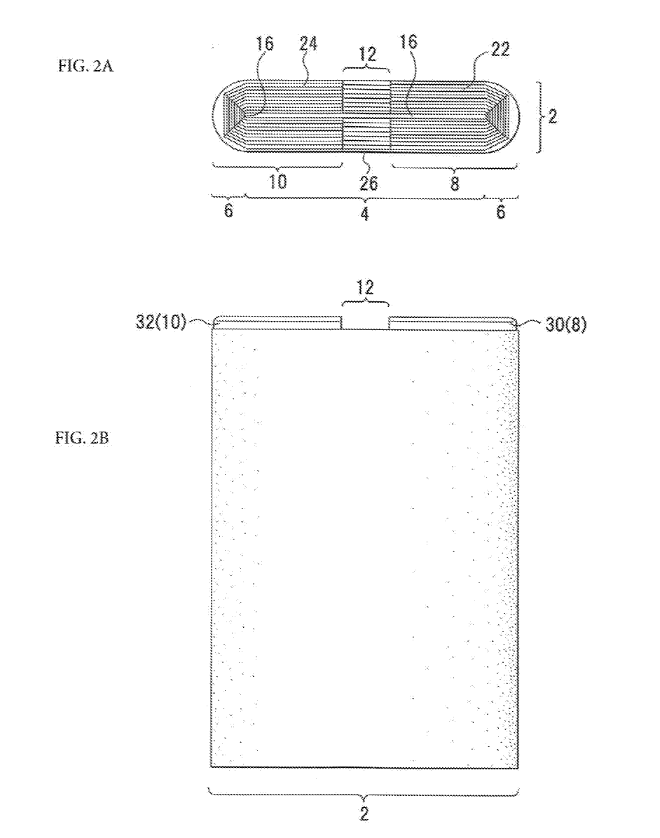

FIG. 2 depicts a configuration example of the capacitor element.

For example, as depicted in A of FIG. 2, the capacitor element 2 has a foil-like positive electrode body 22 and a foil-like negative electrode body 24 present therein as the polarizable electrode bodies, the positive electrode body 22 and the negative electrode body 24 are layered with a separator 26 therebetween, width of the separator 26 is larger than those of these electrode bodies, and the positive electrode body 22, the negative electrode body 24 and the separator 26 are then wound for the capacitor element 2 to be formed. The separator 26 is arranged, for example, not only between the positive electrode body 22 and the negative electrode body 24 but also on the inner layer side and the outer layer side of the capacitor element 2 in the wound state.

each of the positive electrode body 22 and the negative electrode body 24 is, for example, a polarizable electro body by forming an activated carbon layer on both sides of an aluminum foil as a current collecting electrode, and such positive electrode body 22 and negative electrode body 24 are used. The separator 26 is, for example, an electrolytic paper sheet.

For example, as depicted in B of FIG. 2, the capacitor element 2 is formed in a flattened column-like, has, on one end face side of the capacitor element 2, an insulting space 12 and exposes edge portions 30 and 32 of the positive electrode body 22 and the negative electrode body 24. The positive electrode portion 8 and the negative electrode portion 10 are formed by bending the end faces of the edge portions 30 and 32 to the side of the hollow portion 16 and shaping the end faces of the edge portions 30 and 32 to be flat.

### Connection Process for Current Collecting Plates and Electrode Bodies

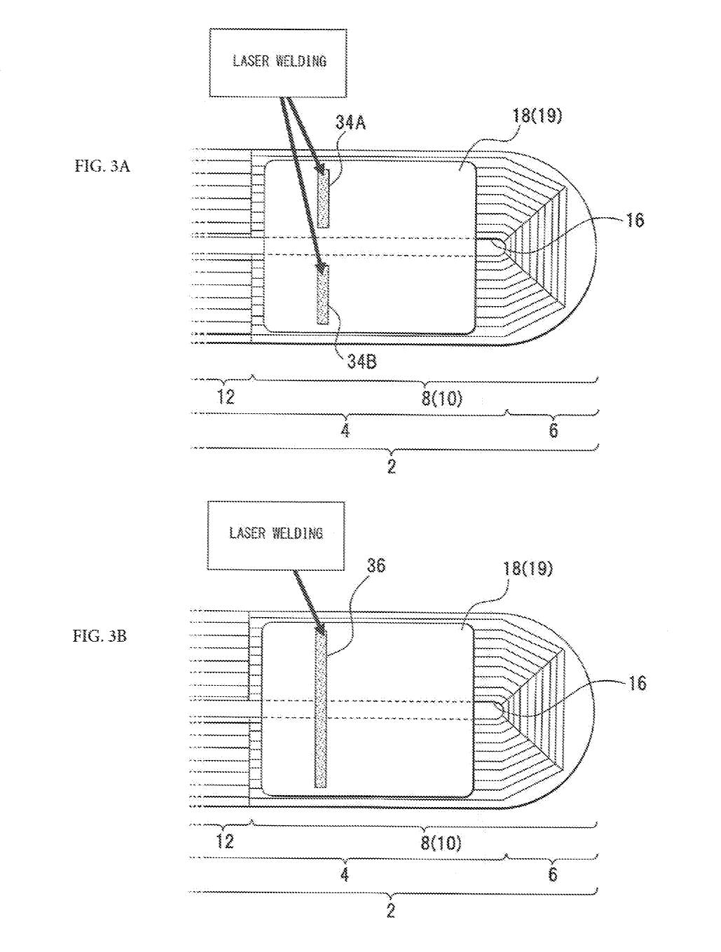

FIG. 3 depicts an example of a connection process for the capacitor element and the current collecting plates.

In this connection process, for example, as depicted in A of FIG. 3, connecting portions 34A and 34B are formed each by welding one point on a flat face of each of the current collecting plates 18 and 19. For example, as depicted in A of FIG. 3, the welding is executed in a direction intersecting the positive electrode body 22, the negative electrode body 24, and the separator 26 that are layered with each other, as the welding direction. For example, the welding may be executed from the outer circumference side of the capacitor element toward the direction of the hollow portion 16 or the welding may be executed from the hollow portion 16 toward the outer circumference side of the capacitor element 2, as the procedure for the welding. Otherwise, the welding may be executed from the side of one end of the flattened portion 4 toward the side of the hollow portion 16, the welding may be discontinued on the hollow portion 16, the welding may be started at the timing at which the hollow portion 16 is passed over, and the welding may be executed from the hollow portion 16 toward the outer circumference side of the capacitor element 2, as the welding procedure. The welding is executed for both ends of the flattened portions 4 of the capacitor element 2 while any welding is avoided for the hollow portion 16.

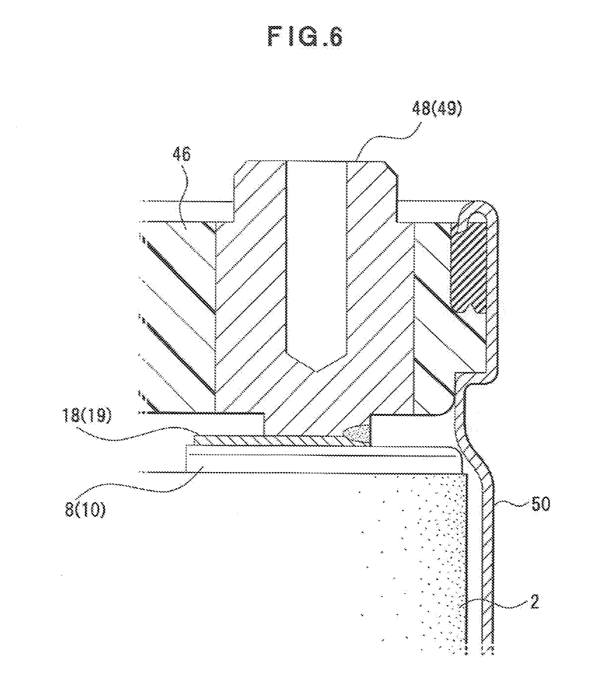

Welding may be executed at any positions avoiding, for example, the connecting positions of terminal parts 48 and 49 depicted in FIG. 6 to be connected onto the current collecting plates 18 and 19 or welding may be executed at plural positions, as the welding positions. The connecting positions of the terminal parts 48 and 49 are set to be, for example, on the flat faces of the current collecting plates 18 and 19 and on the sides of the end portions on the side of the curved portions 6. The current collecting plates 18 and 19, and the terminal parts 48 and 49 can thereby be respectively connected to each other by welding the side face sides thereof to each other.

The welding direction is set to be, for example, the direction intersecting the electrode bodies and the separator 26, and is not limited to the case of the perpendicular intersection. In the welding process, for example, on the flat faces of the current collecting plates 18 and 19, the welding may be executed in a direction at an oblique angle to the electrode bodies and the separator 26 that are layered with each other. The connecting portions 34A and 34B can each be set to be long by executing the welding in the direction at an oblique angle as above.

In addition, for example, as depicted in B of FIG. 3, single connecting portion 36 may be formed by executing continuous welding in a series of processes for the flat face of each of the current collecting plates 18 and 19 from the flattened portion 4 on the one end side of the capacitor element 2 toward the flattened portion 4 on the other end side thereof, as the connection process. The length of the connecting portion 36 is set to be a welding length such that the welding spanning over the hollow portion 16 is executed for at least the positive electrode portion 8 or the negative electrode portion 10 on the side of the flattened portions 4 on both sides.

The connecting portion 36 realizes the welding in the direction intersecting the electrode bodies and the separator 26 that are layered with each other, by, for example, linearly executing welding from the flattened portion 4 of the capacitor element 2 toward the side of the hollow portion 16. For example, the connecting portion 36 is not limited to that of the case where the connecting portion 36 is linearly formed for the electrode bodies and the separator 26, and may be welded in an oblique direction by varying the angle thereof.

### Manufacturing Steps of Capacitor

A capacitor manufacturing method will be described including a formation process for the capacitor element 2 and a connection process for the current collecting plates 18 and 19. The capacitor manufacturing steps are an example of the capacitor manufacturing method of the present invention.

(A) In the capacitor manufacturing process, for example, the positive electrode body 22, the negative electrode body 24, and the separator 26 are placed on each other and a winding process is executed therefor.

(B) After the winding, the edge portions 30 and 32 of the positive electrode body 22 and the negative electrode body 24 are pulled out onto the side of one end face of the capacitor element 2 to form the positive electrode portion 8 and the negative electrode portion 10 as the electrode portions.

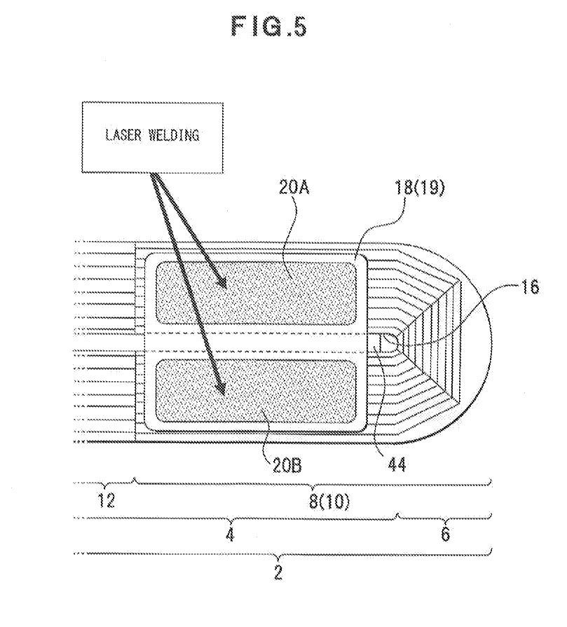

(C) For example, the capacitor element 2 may be pressed in a predetermined direction from the exterior side and thereby be squashed to shape the flattened shape that includes the flattened portions 4 and the curved portions 6, as the formation process of the capacitor element 2. In this case, a plate-like insulating spacer 44 depicted in FIG. 5 may be inserted into the hollow portion 16 that is the center of the capacitor element 2.

(D) After the formation process, the current collecting plate 18 on the positive electrode side is connected to the positive electrode portion 8 of the capacitor element 2, and the current collecting plate 19 on the negative electrode side is connected to the negative electrode portion 10 thereof, by laser welding.

(E) An opening sealing body 46 depicted in FIG. 6 is disposed on the capacitor element 2 through the current collecting plates 18 and 19, and the current collecting plates 18 and 19, and the terminal parts 48 and 49 of the opening sealing body 46 are laser-welded to each other.

(F) The capacitor element 2 is accommodated together with an electrolytic solution into a case member 50 depicted in FIG. 6 and, at this time, an opening of the case member 50 is sealed by the opening sealing body 46. The opening sealing body 46 is welded from, for example, the side of an outer cover of the case member, or a swaging process executed by pressing is applied to the opening sealing body 46. The opening sealing body 46 is, for example, an opening sealing pate. The terminal part 48 is, for example, a positive electrode terminal and the terminal part 49 is, for example, a negative electrode terminal.

### Effect of First Embodiment

According to the configuration, the following effects are achieved.

(1) Simplification of terminal connection is facilitated because the electrode portions, and the terminal parts 48 and 49 disposed on the opening sealing body 46 are connected to each other through the current collecting plates 18 and 19. In addition, the connection can be facilitated. Because a wide range in the electrode portion is connected to the current collecting plate, a large lead portion can be secured and reduction of the resistance can be facilitated.

(2) The flattened portions 4 of the capacitor element 2 are connected to the current collecting plates 18 and 19 arranged extending over the hollow portion 16, and the capacitor can cope with any restoring forces generated in the electrode bodies and the shape of the capacitor element 2 can be maintained.

(3) Because the current collecting plates 18 and 19 avoid any deformation of the flattened portions, the contact state of the layered electrode bodies can be maintained and reduction of the internal resistance of the capacitor element 2 can be facilitated.

(4) The connection between the capacitor element 2 and the current collecting plates 18 and 19 can be made robust between the flattened portions 4 facing each other, and the shape of the capacitor element 2 can be stabilized by executing the welding on the end faces of the current collecting plates 18 and 19 arranged extending over the hollow portion 16.

(5) Any deformation of the flattened portions 4 of the capacitor element 2 in a direction away from the hollow portion 16 can be blocked by setting the welding direction to be the direction intersecting the electrode bodies and the separator 26 that are layered with each other. Because the capacitor element 2 has the electrode bodies and the separator 26 wound therein, tensions act on, for example, the sides of the curved portions 6 that are in the wound portion. The restoring forces of the electrode bodies and the separator 26 are thereby generated in the curved portions 6, and a force to outspread acts on the curved portions 6 to release the wound state. When the curved portions 6 are outspread, the flattened portions 4 on both sides of the curved portions 6 are displaced in the direction away from the hollow portion 16 and simultaneously receive the restoring forces from both sides of the flattened portions 4. The straight line-like shape therefore cannot be maintained. The capacitor element 2 is released from its flattened shape to have a circular shape or an oval shape, and the width thereof is increased. The shape of the capacitor element 2 can be maintained by enhancing the supporting strength of the element by the welding of the current collecting plates 18 and 19.

(6) The possibility that spatters produced during the welding are scattered in the hollow portion 16 and scattered particles remain inside the capacitor element 2 can be reduced by executing the welding avoiding the portions that are of the current collecting plates 18 and 19 and are extending over the hollow portion 16. Otherwise, the output of the laser may be reduced to be lower than that for the points to be welded when the laser beam scans the portions that are of the current collecting plates 18 and 19 and face the hollow portion 16. Production of any spatter from the current collecting plates 18 and 19 placed on the hollow portion 16 can be suppressed, production of any spatter can be suppressed when the laser is again output for entering the portion to be welded, and the possibility that spatters are scattered in the hollow portion 16 and scattered particles remain inside the capacitor element 2 can be reduced, by executing as above.

(7) When the welding is executed in a series of processes on the current collecting plates 18 and 19 spanning over the hollow portion 16, the connecting process is facilitated and the labor for the manufacture can be reduced.

(8) The current collection range can be taken to be wide in addition to enhancement of the connection strength between the current collecting plates and the electrode bodies by welding the current collecting plates 18 and 19 at an oblique angle to the electrode bodies and the separator 26 that are layered with each other.

(9) The lead distances from the electrode bodies are reduced, and reduction of the internal resistance and reduction of equivalent series resistance (ESR) can be facilitated by welding the current collecting plates 18 and 19 at the positions close to the side of the center of the capacitor element 2.

(10) When the spacer 44 is inserted into the hollow portion 16, the hollow portion 16 is filled with the spacer 44 and scattering any spatter in the hollow portion 16 can therefore be suppressed. The bending process can be executed bringing the end face of the spacer 44 into contact with the end faces of the edge portions 30 and 32 by setting the protrusion height of the spacer 44 to match with the bent portions of the edge portions 30 and 32. The connection faces on the side of the hollow portion 16 of the edge portions 30 and 32 are stabilized, and the positive electrode portion 8 and the negative electrode portion 10, and the current collecting plates 18 and 19 can reliably be connected to each other by executing the above.

(11) Any adhesion state of the outer circumference portion of the capacitor element 2 to the inner wall of the case can be prevented when the capacitor element 2 is enclosed in the case member 50, by blocking any expansion of the capacitor element 2 by welding the side of the flattened portions 4 of the capacitor element 2. Because a gap can thereby be maintained between the inner wall of the case and the capacitor element 2 even when a gas is produced in the case member, the stability and the reliability of the capacitor can be maintained without blocking any discharge of the gas.

### Second Embodiment

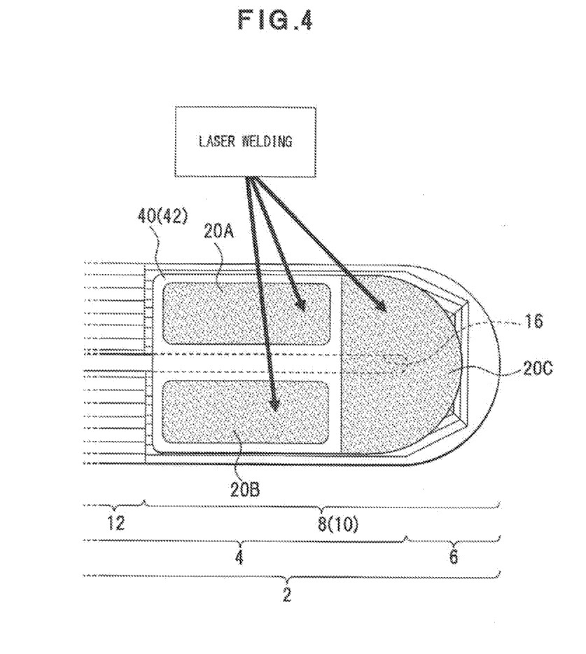

FIG. 4 depicts a configuration example of the capacitor element and the current collecting plates according to a second embodiment. The configuration depicted in FIG. 4 is an example and the present invention is not limited to this configuration.

In the capacitor element 2 of this embodiment, for example, as depicted in FIG. 4, current collecting plates 40 and 42 are each connected on the flattened portions 4 side of the electrode body having the positive electrode portion 8 or the negative electrode portion 10 formed therein and also on the curved portion 6 side thereof. As above, the current collecting plates 40 and 42 each include a flat face portion that extends over the hollow portion 16 and that covers the flattened portion 4 and a curved face portion that is integrally formed with the flat face portion and that covers the curved portion 6. The curved face portion is formed to have, for example, a curved shape matching with the shape of the curved portion 6.

Laser welding is used for connecting the current collecting plates 40 and 42, and the electrode portions to each other. The welding positions are present, for example, in the connection ranges 20A and 20B arranged on the flattened portions 4 of at least the positive electrode portion 8 or the negative electrode portion 10 for the flat face portions of the current collecting plates 40 and 42 and, in addition, are present in a connection range 20C on the curved portion 6 for the curved face portion. The connecting portions formed by the welding may each be formed, for example, at one welding step with a predetermined length in each of the connection ranges 20A, 20B, and 20C, or may be formed by welding plural points in each of the connection ranges 20A, 20B, and 20C.

According to the above configuration, in addition to the effect of the embodiments, the supporting strength for the capacitor element 2 by the current collecting plates 40 and 42 can additionally be enhanced, and stability of the shape of the capacitor element 2 can be facilitated. The electrode portions are shaped by folding to the side of the hollow portion 16 the edge portions 30 and 32 of the positive electrode body 22 and the negative electrode body 24 exposed on the side of the one end face of the capacitor element 2 for the edge portions 30 and 32 to shape flat faces, and the surface of the electrode portion is shaped to be flat. In this case, because the curved portions 6 are shaped by the folded edge portions 30 and 32 having overlaps, the surface is hard and the connection faces for the current collecting plates 18 and 19 are stable. The current collecting plates 18 and 19 are stable even when the current collecting plates 18 and 19 are placed thereon, and the connection property is stable. On the other hand, because the flattened portions 4 are located on the side of the center of the capacitor element 2, the lead distance is short, and reduction of the internal resistance and reduction of the ESR can be facilitated.

### Other Embodiments

(1) The case where the polarizable electrode bodies and the separator 26 placed on each other are wound to have a flattened shape has been described for the capacitor element 2 in the embodiments while the capacitor element 2 is not limited to this. The capacitor element 2 may be, for example, a layered element formed by a pair of polarizable electrode bodies through the separator 26 sandwiched therebetween.

(2) The case where the hollow portion 16 is a cavity or the electrode bodies facing each other on the side of the flattened portion 4 contact to each other has been described in the embodiments while the configuration is not limited to this. For example, the spacer 44 depicted in FIG. 5 may be inserted into the hollow portion 16. The spacer 44 is inserted into the hollow portion 16, for example, during the winding of the electrode bodies or the shaping of the capacitor element 2, or after the shaping process. The spacer 44 is formed from, for example, a hard and insulating material that is also highly strong and light-weight, such as a plate material of a cardboard or a fluorine resin. The spacer 44 has its side face contacting to the side of the inner wall of the electrode bodies and the width of the spacer 44 is equal to the space of the hollow portion 16 of the capacitor element 2. Maintenance of the shape of the capacitor element 2 can be facilitated and, in addition, the contact between the electrode bodies can be enhanced, the internal resistance can be reduced, and the spacer 44 contacts the electrode bodies facing the hollow portion 16, by causing the spacer 44 to be present in the hollow portion 16 as above. Any deformation of the side of the flattened portions 4 in the direction away from the hollow portion 16 can therefore be blocked and the stability of the shape of the capacitor element 2 can further be enhanced.

(3) The current collecting plates 18 and 19 each have a shape to cover only the flattened portions 4 side in the first embodiment while the shape thereof is not limited to this. The shape may be a shape to cover the curved portion 6 like the shape of each of the current collecting plates 18 and 19 in the second embodiment. The terminal parts 48 and 49 on the opening sealing body 46 are arranged to be placed on the current collecting plates 18 and 19, and the contact portions between the current collecting plates 18 and 19, and the terminal parts 48 and 49 are connected by laser welding while scattering of any spatter produced at the welding step to the capacitor element 2 can be suppressed by arranging the current collecting plates 18 and 19 to cover the flattened portions 4 and the curved portions 6.

The most preferred embodiments and the like of the present invention have been described as above while the present invention is not limited by the above description and those skilled in the art can naturally make various modifications and various changes thereto based on the gist of invention described in the claims or disclosed in the description. Needless to say, those modifications and changes are encompassed in the scope of the present invention.

### INDUSTRIAL APPLICABILITY

According to the present invention, for a flattened-shape capacitor element, any deformation for the capacitor element to expand can be blocked, and stabilization of the shape of the capacitor and reduction of the internal resistance thereof can be facilitated by welding at least the flattened portions side of the current collecting plates arranged extending over the hollow portion, to the flattened-shape capacitor element. The present invention is therefore useful.

### REFERENCE SIGNS LIST

2 capacitor element
4 flattened portion
6 curved portion
8 positive electrode portion
10 negative electrode portion
12 insulating space
16 hollow portion
18, 19, 40, 42 current collecting plate
20A, 20B, 20C connection range
22 positive electrode body
24 negative electrode body
26 separator
30, 32 edge portion
34A, 34B, 36 connecting portion
36 connecting portion
44 spacer
46 opening sealing body
48, 49 terminal part
50 case member

1. A capacitor comprising:
a capacitor element including a positive electrode body and a negative electrode body that are layered with a separator, the positive electrode body, the negative electrode body and the separator being wound, the capacitor element being formed in a flattened shape and having curved portions and flattened portions;
a positive electrode portion formed onto one end face of the capacitor element, the positive electrode portion being pulled out from the positive electrode body;
a negative electrode portion formed onto the same end face as the positive electrode portion, the negative electrode portion being pulled out from the negative electrode body, an insulating space being disposed between the negative electrode portion and the positive electrode portion; and
current collecting plates on a positive electrode side and a negative electrode side connected to a side of the flattened portions on the positive electrode portion and the side of the flattened portions on the negative electrode portion by welding in a direction intersecting the positive electrode body and the negative electrode body that are layered, respectively.

2. The capacitor according to claim 1, wherein
the current collecting plates on the positive electrode side and the negative electrode side are each arranged on the flattened portions and one of the curved portions, and are connected by welding on the curved portions.

3. The capacitor according to claim 1, wherein
a side of the flattened portions facing each other through a central portion of the capacitor element is connected onto one of the current collecting plates by a series of welding processes.

4. The capacitor according to claim 1, wherein
a spacer is arranged in the central portion of the capacitor element.

5. A capacitor manufacturing method comprising the steps of:
winding a positive electrode body and a negative electrode body that are layered with a separator, and forming a flattened-shape capacitor element that has curved portions and flattened portions;
forming, on one end face of the capacitor element, a positive electrode portion that is pulled out from the positive electrode body and a negative electrode portion that is pulled out from the negative electrode body, and disposing an insulating space between the negative electrode portion and the positive electrode portion; and
connecting a positive electrode terminal disposed on an opening sealing plate and the positive electrode portion to each other through a current collecting plate on a positive electrode side, the opening sealing plate being for sealing an opening of a case member accommodating the capacitor element, and connecting a negative electrode terminal on the opening sealing plate and the negative electrode portion to each other through a current collecting plate on a negative electrode side, wherein
the capacitor manufacturing method further comprises the step of
connecting each of the current collecting plates onto the positive electrode portion or the negative electrode portion by welding in a direction intersecting the positive electrode body and the negative electrode body that are layered.

6. The capacitor according to claim 2, wherein
a side of the flattened portions facing each other through a central portion of the capacitor element is connected onto one of the current collecting plates by a series of welding processes.

7. The capacitor according to claim 2, wherein
a spacer is arranged in the central portion of the capacitor element.

8. The capacitor according to claim 3, wherein
a spacer is arranged in the central portion of the capacitor element.

9. The capacitor according to claim 6, wherein
a spacer is arranged in the central portion of the capacitor element.
